(19) United States
(12) Patent Application Publication
(10) Pub. No.: US 2024/0331546 A1
(43) Pub. Date: Oct. 3, 2024

(54) ROADSIDE DEVICE, VEHICLE, AND CONTROL DEVICE

(71) Applicant: PANASONIC AUTOMOTIVE SYSTEMS CO., LTD., Kanagawa (JP)

(72) Inventors: Yongxiang WANG, Kanagawa (JP); Masaharu MATSUMOTO, Kanagawa (JP); Takenobu ARIMA, Kanagawa (JP); Akiyoshi NAGUMO, Kanagawa (JP)

(73) Assignee: PANASONIC AUTOMOTIVE SYSTEMS CO., LTD., Kanagawa (JP)

(21) Appl. No.: 18/741,191

(22) Filed: Jun. 12, 2024

Related U.S. Application Data
(63) Continuation of application No. PCT/JP2022/029538, filed on Aug. 1, 2022.

(30) Foreign Application Priority Data
Dec. 15, 2021 (JP) 2021-203562

(51) Int. Cl. G08G 1/16; G08G 1/01; G08G 1/04; G08G 1/052

(52) U.S. Cl. CPC G08G 1/166; G08G 1/0116; G08G 1/04; G08G 1/052; G08G 1/164

(57) ABSTRACT

A roadside device set to be installed at an intersection where a traffic light is installed, the roadside device includes an imaging unit configured to image a vehicle that enters the intersection, an input unit set to receive a state of the traffic light, and a wireless communication unit. When the traffic light for the vehicle is a red signal or is scheduled to switch to the red signal within a predetermined time, and a speed of the vehicle is equal to or greater than a predetermined threshold or the speed of the vehicle is increased, the wireless communication unit transmits information indicating that a runaway vehicle enters the intersection.

### CROSS-REFERENCE TO RELATED APPLICATIONS

The present application is a continuation application of PCT/JP2022/029538 that claims priority to Japanese Patent Application No. 2021-203562 filed on Dec. 15, 2021, the entire contents of which are incorporated herein by reference.

### TECHNICAL FIELD

The present disclosure relates to a roadside device, a vehicle, and a control device.

### BACKGROUND ART

There is a need to prevent an accident that occurs when a vehicle runs away due to a driver depressing a brake pedal and an accelerator pedal erroneously. Patent Literature 1 discloses a vehicle runaway prevention system including a switch arranged at a position where an accelerator pedal comes into contact with a pedal arm when being depressed to an effective maximum value range, and a runaway prevention device that controls a driving force control device and a brake control device based on an output of the switch. The runaway prevention device transmits a driving force limitation command to the driving force control device when a duration of an abnormal depression of the accelerator pedal detected by the switch exceeds a first threshold.

### CITATION LIST

### Patent Literature

Patent Literature 1: JP2021-041893A
Patent Literature 2: JP2021-051414A

### Technical Problem

However, when the accelerator pedal is not depressed to the effective maximum value range, a vehicle may run away. When the vehicle that runs away (hereinafter referred to as a runaway vehicle) is present, there is also a need to minimize damage.

An object of the present disclosure is to provide a technique for reducing damage caused by a runaway vehicle.

### SUMMARY OF INVENTION

According to an aspect of the present disclosure, there is provided a roadside device set to be installed at an intersection where a traffic light is installed, and the roadside device includes: an imaging unit configured to image a vehicle that enters the intersection; an input unit set to receive a state of the traffic light; and a wireless communication unit. When the traffic light for the vehicle is a red signal or is scheduled to switch to the red signal within a predetermined time, and a speed of the vehicle is equal to or greater than a predetermined threshold or the speed of the vehicle is increased, the wireless communication unit transmits information indicating that a runaway vehicle enters the intersection.

These comprehensive or specific aspects may be implemented by a system, a device, a method, an integrated circuit, a computer program, or a recording medium, or any combination of the system, the device, the method, the integrated circuit, the computer program, and the recording medium.

According to the present disclosure, the damage caused by the runaway vehicle can be reduced.

### BRIEF DESCRIPTION OF DRAWINGS

FIG. 1 is a schematic diagram showing a situation in which a vehicle 20A according to the present embodiment enters an intersection as a runaway vehicle;

FIG. 2 is a block diagram showing a configuration example of a runaway vehicle damage reduction system according to the present embodiment;

FIG. 3 is a flowchart showing an example of processing executed by a roadside device according to the present embodiment;

FIG. 4 is a flowchart showing an example of processing executed by the vehicle 20A according to the present embodiment;

FIG. 5 is a flowchart showing an example of processing executed by a mobile terminal according to the present embodiment;

FIG. 6 is a flowchart showing an example of processing executed by a vehicle 20B according to the present embodiment; and

FIG. 7 is a schematic diagram showing an example of an operation of the vehicle 20B that receives runaway prevention information according to the present embodiment.

### DESCRIPTION OF EMBODIMENTS

Hereinafter, an embodiment of the present disclosure will be described in detail with reference to the drawings as appropriate. However, more detailed description than necessary may be omitted. For example, detailed description of already well-known matters and redundant description of substantially the same configuration may be omitted. This is to avoid the following description from being unnecessarily redundant and facilitate understanding for those skilled in the art. The accompanying drawings and the following description are provided for those skilled in the art to sufficiently understand the present disclosure, and are not intended to limit the subject matter described in claims.

### Present Embodiment

### <Overview>

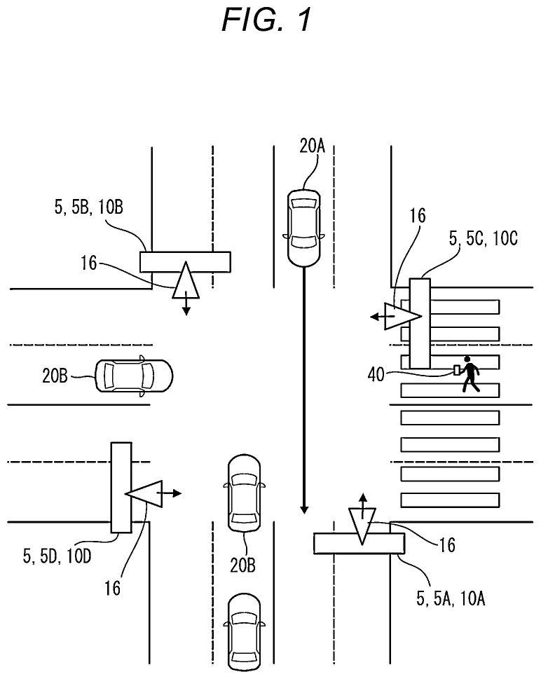

FIG. 1 is a schematic diagram showing a situation in which a vehicle 20A according to the present embodiment enters an intersection as a runaway vehicle. In the present embodiment, for convenience, an upper direction in the drawings is north, a lower direction in the drawings is south, a right direction in the drawings is east, and a left direction in the drawings is west. In the present embodiment, when roadside devices are distinguished, reference numerals are represented by a combination of numbers and alphabets such as roadside devices 10A, 10B, . . . , and when the roadside devices are not distinguished, the reference numerals are represented only by numbers such as a roadside device 10. A method for representing the reference numerals is the same for a traffic light and a vehicle.

In the vehicle 20A shown in FIG. 1, for example, when a driver erroneously depresses a brake pedal and an accelerator pedal, or some abnormality occurs in the driver, the vehicle 20A runs away and enters the intersection, causing great damage. A runaway vehicle damage reduction system according to the present embodiment is a system for appropriately detecting a runaway vehicle and reducing damage caused by the runaway vehicle.

The runaway vehicle damage reduction system includes roadside devices 10 (10A, 10B, 10C, and 10D) installed at intersections, vehicles 20 (20A and 20B) capable of wireless communication with the roadside devices 10, and a mobile terminal 40 capable of wireless communication with the roadside devices 10. However, the runaway vehicle damage reduction system may not include at least one of the vehicle 20 and the mobile terminal 40.

In the present embodiment, as shown in FIG. 1, a case will be described where the roadside device 10A mounted on a traffic light 5A for a lane on which the vehicle 20A heading from north to south is traveling determines whether the vehicle 20A is a runaway vehicle. However, contents of the present embodiment can also be applied to other traffic lights 5B, 5C, and 5D, other roadside devices 10B, 10C, and 10D, and other vehicles 20B.

The roadside device 10A determines whether the vehicle 20A that enters the intersection is the runaway vehicle. Details of the determination method will be described later. When determining that the vehicle 20A is the runaway vehicle, the roadside device 10A may wirelessly transmit, to the vehicle 20A, runaway determination information indicating that the vehicle 20A is the runaway vehicle. When receiving the runaway determination information indicating that the vehicle 20A is the runaway vehicle, the vehicle 20A may automatically sound an alarm device (horn), decelerate, or move to a safe position and stop.

When determining that the vehicle 20A is the runaway vehicle, the roadside device 10A may notify that the runaway vehicle enters the intersection from a speaker installed at the intersection.

When determining that the vehicle 20A is the runaway vehicle, the roadside device 10A may wirelessly transmit, by broadcasting, runaway vehicle information indicating that the runaway vehicle enters the intersection. When receiving the runaway vehicle information, another vehicle 20B present near the intersection may automatically decelerate or notify a driver of presence of the runaway vehicle. When receiving the runaway vehicle information, the mobile terminal 40 carried by a pedestrian present near the intersection may notify the pedestrian that the runaway vehicle enters the intersection.

In this way, when the runaway vehicle 20A is detected, the roadside device 10A controls the runaway vehicle 20A, or informs the other vehicle 20B or the mobile terminal 40 of the pedestrian present near the runaway vehicle 20A of the presence of the runaway vehicle. This can reduce the damage caused by the runaway vehicle 20A. This will be described in detail below.

### <Configuration of Runaway Vehicle Damage Reduction System>

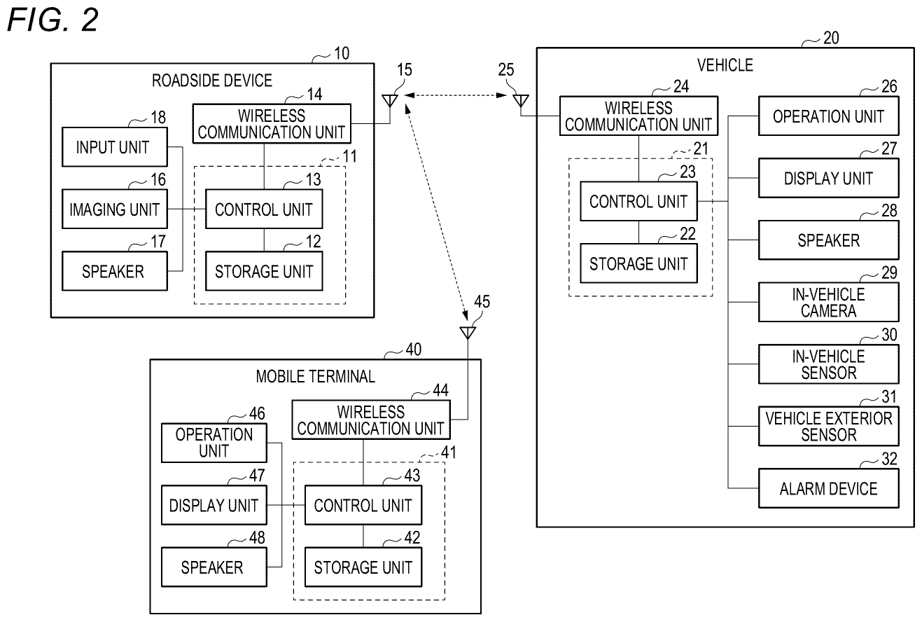

FIG. 2 is a block diagram showing a configuration example of the runaway vehicle damage reduction system according to the present embodiment.

The runaway vehicle damage reduction system includes the roadside device 10, the vehicle 20, and the mobile terminal 40. The roadside device 10, the vehicle 20, and the mobile terminal 40 may be capable of V2X communication (wireless communication) with one another. The V2X communication may include at least one of vehicle to infrastructure (V2I) communication, vehicle to vehicle (V2V) communication, vehicle to pedestrian (V2P) communication, and vehicle to network (V2N) communication. Examples of the V2X communication method include dedicated short range communications (DSRC) and cellular-V2x (C-V2X). The V2X communication method may correspond to 4G or 5G.

### <<Configuration of Roadside Device>>

The roadside device 10 includes a control device 11, a wireless communication unit 14, an antenna 15, an imaging unit 16, and a speaker 17.

The control device 11 is a device that controls functions of the roadside device 10, and includes a storage unit 12 and a control unit 13.

The storage unit 12 stores data, computer programs, and the like handled by the roadside device 10. The storage unit 12 may be implemented as a read-only memory (ROM), a random access memory (RAM), a flash memory, or a combination thereof.

The control unit 13 implements the functions of the roadside device 10 by reading and executing the data and the computer programs stored in the storage unit 12. The control unit 13 may be read as another term such as a control circuit, an arithmetic circuit, a processor, a controller, a central processing unit (CPU), or a large scale integrated circuit (LSI).

The wireless communication unit 14 transmits and receives wireless signals through the antenna 15. For example, the wireless communication unit 14 performs wireless communication with the vehicle 20 or the mobile terminal 40 by V2X communication.

The imaging unit 16 is set to image a vehicle on a road in a predetermined imaging direction. For example, the imaging unit 16 of the roadside device 10A shown in FIG. 1 is set to image the vehicle 20A heading from north to south. That is, the imaging direction of the imaging unit 16 of the roadside device 10A is northward. The imaging unit 16 captures an image in the imaging direction and generates a captured image. For example, in the captured image captured by the imaging unit 16 of the roadside device 10A, the vehicle 20A heading from north to south is captured. The captured image may be either a moving image or a still image.

The speaker 17 is installed at the intersection and outputs audio. For example, the speaker 17 outputs audio informing (notifying) that the runaway vehicle enters the intersection. Alternatively, the speaker 17 may output a simple alarm audio indicating (notify) that the runaway vehicle enters the intersection.

A state of the traffic light 5 is input to an input unit 18. For example, information indicating whether the traffic light 5 is currently a red signal, a yellow signal, or a blue signal, information indicating a remaining time until the current signal switches, and the like are input to the input unit 18. Information indicating the red signal may be read as information instructing the vehicle to stop. Information indicating the yellow signal may be read as information requesting the vehicle to stop. Information indicating the blue signal may be read as information permitting the vehicle to travel. The blue signal may be read as a green signal.

### <<Configuration of Vehicle>>

The vehicle 20 includes a control device 21, a wireless communication unit 24, an antenna 25, an operation unit 26, a display unit 27, a speaker 28, an in-vehicle camera 29, an in-vehicle sensor 30, an vehicle exterior sensor 31, and an alarm device 32.

The control device 21 is a device that controls functions of the vehicle 20, and includes a storage unit 22 and a control unit 23. The control device 21 may be mounted on the vehicle 20 as one or more electronic control units (ECUs).

The storage unit 22 stores data, computer programs, and the like handled by the vehicle 20. The storage unit 22 may be implemented as a ROM, a RAM, a flash memory, or a combination thereof.

The control unit 23 implements the functions of the vehicle 20 by reading and executing the data and the computer programs stored in the storage unit 22.

The wireless communication unit 24 transmits and receives wireless signals through the antenna 25. For example, the wireless communication unit 24 performs wireless communication with the roadside device 10 by V2X communication.

The operation unit 26 receives an operation on the vehicle 20 from the driver. Examples of the operation on the vehicle 20 include a steering wheel operation, an accelerator pedal operation, and a brake pedal operation.

The display unit 27 is provided in the vehicle 20 and outputs various types of image information to the driver. Examples of the display unit 27 include a liquid crystal display or an organic EL display.

The speaker 28 is provided in the vehicle 20 and outputs various types of audio information to the driver.

The in-vehicle camera 29 is provided in the vehicle 20, images a state of the driver, and generates a captured image. The captured image may be either a moving image or a still image.

The in-vehicle sensor 30 is installed in the vehicle 20 and measures the state of the driver. For example, a steering wheel sensor, which is one of the in-vehicle sensors 30, measures whether the driver holds the steering wheel. An accelerator sensor, which is one of the in-vehicle sensors 30, measures a depression amount of the accelerator pedal by the driver. A body temperature sensor, which is one of the in-vehicle sensors 30, measures a body temperature of the driver. The in-vehicle sensor 30 may measure at least one of a blood pressure, a heart rate, and perspiration of the driver.

The vehicle exterior sensor 31 is provided outside the vehicle 20 and measures a surrounding situation outside the vehicle 20. Examples of the vehicle exterior sensor 31 include a light detection and ranging (LiDAR), a camera, and a millimeter wave sensor.

The alarm device 32 outputs alarm audio or audio indicating an alarm to the outside of the vehicle 20.

### <<Configuration of Mobile Terminal>>

The mobile terminal 40 includes a control device 41, a wireless communication unit 44, an antenna 45, an operation unit 46, a display unit 47, and a speaker 48. Examples of the mobile terminal 40 include a smartphone, a tablet, and a smart watch.

The control device 41 is a device that controls functions of the mobile terminal 40, and includes a storage unit 42 and a control unit 43.

The storage unit 42 stores data, computer programs, and the like handled by the mobile terminal 40. The storage unit 42 may be implemented as a ROM, a RAM, a flash memory, or a combination thereof.

The control unit 43 implements the functions of the mobile terminal 40 by reading and executing the data and the computer programs stored in the storage unit 42.

The wireless communication unit 44 transmits and receives wireless signals through the antenna 45. For example, the wireless communication unit 44 performs wireless communication with the roadside device 10 by V2X communication. The wireless communication unit 44 may be wirelessly connected to a cellular network (such as LTE, 4G, and 5G) or Wi-Fi through the antenna 45.

The operation unit 46 receives an operation from a user carrying the mobile terminal 40. The operation unit 46 may include, for example, a touch panel, a button, a switch, and a microphone.

The display unit 47 outputs various types of image information to the user. Examples of the display unit 47 include a liquid crystal display or an organic EL display.

The speaker 48 outputs various types of audio information to the user. Here, the audio information includes simple alarm audio.

### <Processing by Roadside Device>

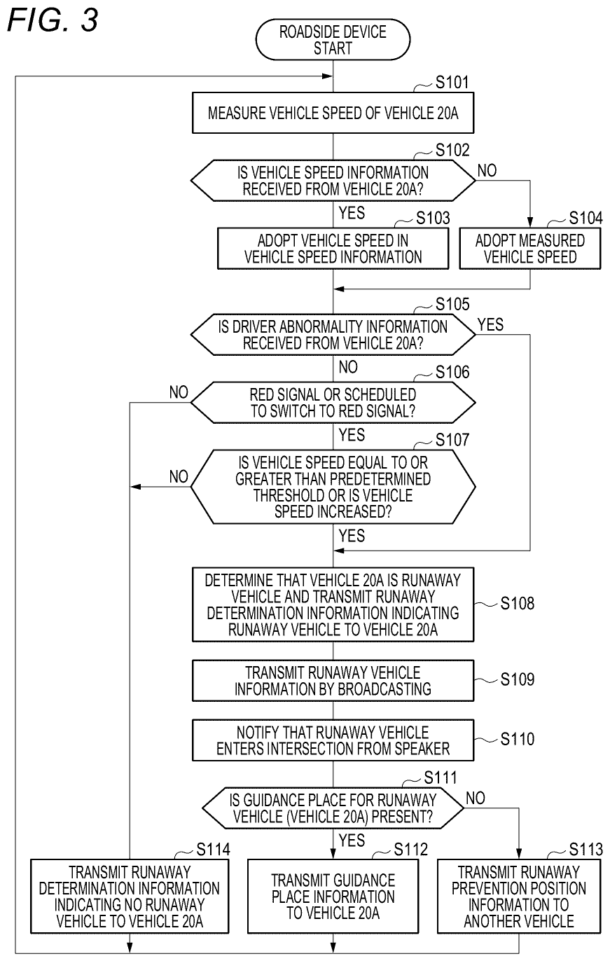

Next, processing executed by the roadside device 10A will be described with reference to FIG. 3. FIG. 3 is a flowchart showing an example of the processing executed by the roadside device 10A according to the present embodiment. In the following description, the processing mainly executed by the roadside device 10A may be read as processing mainly executed by the control device 11 provided in the roadside device 10A.

The roadside device 10A analyzes a moving image captured by the imaging unit 16 and measures a vehicle speed of the vehicle 20A (S101).

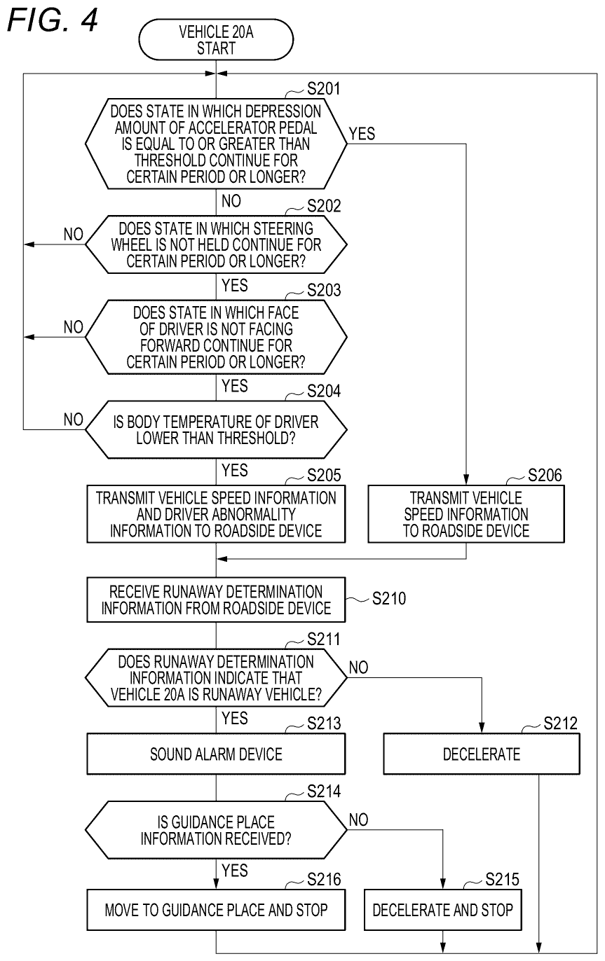

The roadside device 10A determines whether vehicle speed information is received from the vehicle 20A (S102). The vehicle speed information includes a vehicle speed measured by the vehicle 20A. For example, when the vehicle 20A transmits the vehicle speed information in S205 or S206 in FIG. 4 to be described later, the roadside device 10A receives the vehicle speed information.

When receiving the vehicle speed information in S102 (S102: YES), the roadside device 10A adopts the vehicle speed indicated by the vehicle speed information (S103), and advances the processing to S105. Accordingly, the roadside device 10A can more accurately specify the vehicle speed of the vehicle 20A.

When receiving no vehicle speed information in S102 (S103: NO), the roadside device 10A adopts the vehicle speed measured in S101 (S104) and advances the processing to S105. Accordingly, the roadside device 10A can also specify the vehicle speed of the vehicle 20 that cannot transmit the vehicle speed information.

The roadside device 10A determines whether driver abnormality information is received from the vehicle 20A (S105). The driver abnormality information is information indicating that an abnormality occurs in the driver. For example, when the vehicle 20A transmits the driver abnormality information in S205 in FIG. 4 to be described later, the roadside device 10A receives the driver abnormality information. When receiving the driver abnormality information (S105: YES), the roadside device 10A advances the processing to S108.

When receiving no driver abnormality information (S105: NO), the roadside device 10A executes the following processing in S106.

The roadside device 10A acquires information on the traffic light 5A for the vehicle 20A through the input unit 18, and determines whether the traffic light 5A for the vehicle 20A is a red signal or is scheduled to switch to the red signal within a predetermined period (S106). A length of the predetermined period may be different for each traffic light 5 or each intersection.

When the traffic light 5A for the vehicle 20A is not the red signal and is not scheduled to switch to the red signal within the predetermined period (S106: NO), the roadside device 10A transmits, to the vehicle 20A, runaway determination information indicating that the vehicle 20A is not a runaway vehicle (S114), and returns the processing to S101. In this case, even if the vehicle speed of the vehicle 20A is equal to or greater than a predetermined threshold, there is a low possibility that the vehicle 20A runs away because the vehicle passes through the intersection with a blue signal.

When the traffic light 5A for the vehicle 20A is the red signal or is scheduled to switch to the red signal within the predetermined period (S106: YES), the roadside device 10A executes the following processing in S107.

The roadside device 10A determines whether the vehicle speed of the vehicle 20A is equal to or greater than the predetermined threshold or is increased (S107). The vehicle speed may be a vehicle speed adopted in either S103 or S104. A magnitude of the threshold may be different for each traffic light 5 or each intersection.

When the vehicle speed of the vehicle 20A is smaller than the predetermined threshold and is not increased (S107: NO), the vehicle 20A transmits, to the vehicle 20A, the runaway determination information indicating that the vehicle 20A is not the runaway vehicle (S114), and returns the processing to S101. In this case, even when the traffic light 5A is the red signal or switches to the red signal within the predetermined period, the vehicle speed is controlled by the driver, and there is a low possibility that the vehicle 20A runs away.

When the vehicle speed of the vehicle 20A is equal to or greater than the predetermined threshold or is increased (S107: YES), the roadside device 10A determines that the vehicle 20A is the runaway vehicle, and transmits, to the vehicle 20A, runaway determination information indicating that the vehicle 20A is the runaway vehicle (S108). In this case, since the vehicle speed of the vehicle 20A is equal to or greater than the threshold or is increased even though the traffic light 5A is the red signal or is scheduled to switch to the red signal within the predetermined period, there is a high possibility that the vehicle speed is not controlled by the driver and the vehicle 20A runs away.

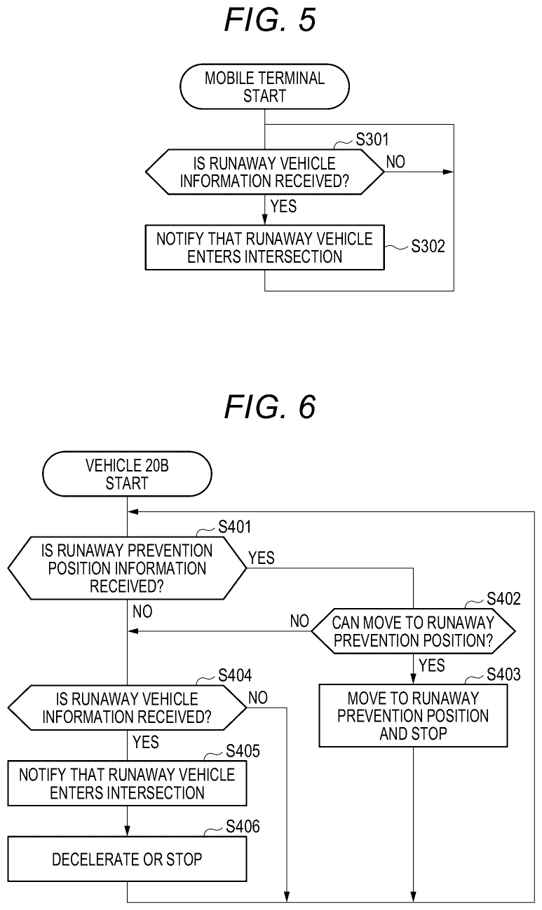

The roadside device 10A wirelessly transmits, by broadcasting, runaway vehicle information indicating that the runaway vehicle (vehicle 20A) enters the intersection (S109). The runaway vehicle information may be received by the mobile terminal 40 in S301 in FIG. 5 to be described later. The runaway vehicle information may be received by another vehicle 20B in S404 in FIG. 6 to be described later.

The roadside device 10A notifies that the runaway vehicle 20A enters the intersection from the speaker 17 installed at the intersection (S110). Accordingly, a pedestrian, a bicycle, a motorcycle, a vehicle, or the like present near the intersection can be informed of presence of the runaway vehicle.

The roadside device 10A determines whether a place (hereinafter referred to as a guidance place) is present where the runaway vehicle 20A can be safely guided (S111). For example, the roadside device 10A analyzes an image captured by the imaging unit 16, and determines that a guidance place is present when an empty space can be detected in front of the vehicle 20A.

When the guidance place for the runaway vehicle 20A is present (S111: YES), the roadside device 10A transmits guidance place information indicating the guidance place (empty space) to the runaway vehicle 20A (S112), and returns the processing to S101. The guidance place information may be received by the vehicle 20A in S214 in FIG. 4 to be described later.

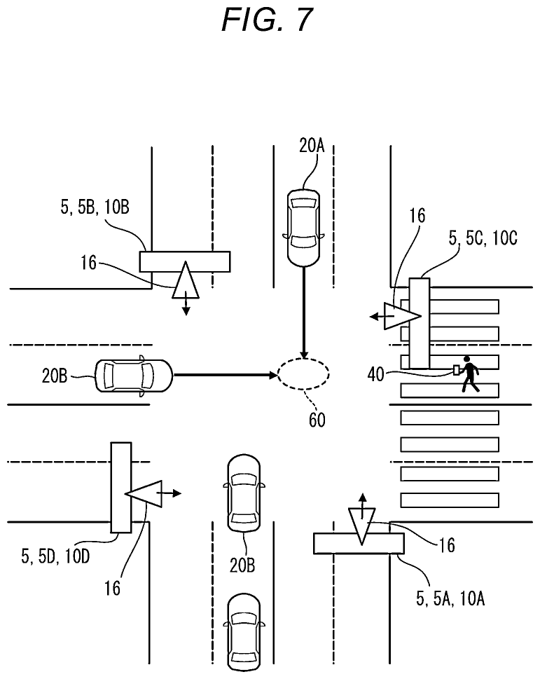

When no guidance place for the runaway vehicle 20A is present (S111: NO), the roadside device 10A transmits runaway prevention position information indicating a runaway prevention position 60 (see FIG. 7) to the other vehicle 20B (S113), and returns the processing to S101. The runaway prevention position information may be received by the vehicle 20B in S401 in FIG. 6 to be described later. Details of the runaway prevention position 60 will be described later (see FIGS. 6 and 7).

### <Processing by Vehicle 20A>

Next, processing executed by the vehicle 20A will be described with reference to FIG. 4. FIG. 4 is a flowchart showing an example of the processing executed by the vehicle 20A according to the present embodiment. In the following description, the processing mainly executed by the vehicle 20A may be read as processing mainly executed by the control device 21 provided in the vehicle 20A.

The vehicle 20A determines whether a state in which a depression amount of the accelerator pedal is equal to or greater than a predetermined threshold continues for a certain period or longer (S201). The depression amount of the accelerator pedal is measured by an accelerator sensor that is one of the in-vehicle sensors 30.

When the state in which the depression amount of the accelerator pedal is equal to or greater than the predetermined threshold continues for the certain period or longer (S201: YES), the vehicle 20A transmits vehicle speed information on the vehicle 20A to the roadside device 10A (S206), and advances the processing to S210.

When the depression amount of the accelerator pedal is smaller than the predetermined threshold, or when a duration of the state in which the depression amount of the accelerator pedal is equal to or greater than the predetermined threshold is shorter than the certain period (S201: NO), the vehicle 20A advances the processing to the following S202.

The vehicle 20A determines whether a state in which the steering wheel is not held continues for a certain period or longer (S202). Whether the steering wheel is held is measured by a steering wheel sensor that is one of the in-vehicle sensors 30.

When the state in which the steering wheel is not held continues for the certain period or longer (S202: YES), the vehicle 20A advances the processing to the following S203.

When the steering wheel is held, or when a duration of the state in which the steering wheel is not held is shorter than the certain period (S202: NO), the vehicle 20A returns the processing to S201.

The vehicle 20A determines whether a state in which a face of the driver is not facing forward continues for a certain period or longer (S203). Whether the face of the driver is facing forward is measured by the in-vehicle camera 29.

When the state in which the face of the driver is not facing forward continues for the certain period or longer (S203: YES), the vehicle 20A advances the processing to the following S204.

When the face of the driver is facing forward, or when a duration of the state in which the face of the driver is not facing forward is shorter than the certain period (S203: NO), the vehicle 20A returns the processing to S201.

The vehicle 20A determines whether a body temperature of the driver is lower than a predetermined threshold (S204). The body temperature of the driver is measured by a body temperature sensor that is one of the in-vehicle sensors 30.

When the body temperature of the driver is lower than the predetermined threshold (S204: YES), the vehicle 20A advances the processing to the following S205.

When the body temperature of the driver is equal to or higher than the predetermined threshold (S204: NO), the vehicle 20A returns the processing to S201.

The vehicle 20A transmits vehicle speed information and driver abnormality information to the roadside device 10A (S205), and advances the processing to the following S210. This is because in this case, there is a high possibility that some abnormality occurs in the driver.

The vehicle 20A receives the runaway determination information transmitted from the roadside device 10A in S108 or S114 in FIG. 3 (S210).

The vehicle 20A determines whether the runaway determination information indicates that the vehicle 20A is the runaway vehicle (S211).

When the runaway determination information indicates that the vehicle 20A is not the runaway vehicle (S211: NO), the vehicle 20A decelerates (S212), and returns the processing to S201.

When the runaway determination information indicates that the vehicle 20A is the runaway vehicle (S211: YES), the vehicle 20A automatically executes audio emission control on the alarm device 32 (horn) (S213). Accordingly, presence of the runaway vehicle 20A can be informed to the surroundings.

The vehicle 20A determines whether the guidance place information (see S112 in FIG. 3) is received (S214).

When receiving no guidance place information (S214: NO), the vehicle 20A automatically executes deceleration control and stop control (S215), and returns the processing to S201.

When receiving the guidance place information (S214: YES), the vehicle 20A automatically moves to the guidance place indicated by the guidance place information while executing the deceleration control, and stops (S216), and returns the processing to S201. Accordingly, since the runaway vehicle 20A is guided to a safe place and stops, damage caused by the runaway vehicle 20A can be reduced.

### <Processing by Mobile Terminal>

Next, processing executed by the mobile terminal 40 will be described with reference to FIG. 5. FIG. 5 is a flowchart showing an example of the processing executed by the mobile terminal 40 according to the present embodiment. In the following description, the processing mainly executed by the mobile terminal 40 may be read as processing mainly executed by the control device 41 provided in the mobile terminal 40.

The mobile terminal 40 determines whether the runaway vehicle information (see S109 in FIG. 3) is received (S301).

When receiving no runaway vehicle information (S301: NO), the mobile terminal 40 repeats the processing in S301.

When receiving the runaway vehicle information (S301: YES), the mobile terminal 40 notifies the pedestrian that the runaway vehicle 20A enters the intersection (S302), and returns the processing to S301. For example, the mobile terminal 40 outputs audio indicating that the runaway vehicle 20A enters the intersection from the speaker 48, displays an image indicating that the runaway vehicle 20A enters the intersection on the display unit 47, or vibrates. Accordingly, the user carrying the mobile terminal 40 can notice the presence of the runaway vehicle 20A.

### <Processing by Vehicle 20B>

Next, processing executed by the vehicle 20B (that is, a vehicle different from the runaway vehicle 20A) present in near the intersection will be described with reference to FIGS. 6 and 7. FIG. 6 is a flowchart showing an example of the processing executed by the vehicle 20B according to the present embodiment. In the following description, the processing mainly executed by the vehicle 20B may be read as processing mainly executed by the control device 21 provided in the vehicle 20B. FIG. 7 is a schematic diagram showing an example of an operation of the vehicle 20B that receives runaway prevention information according to the present embodiment.

The vehicle 20B determines whether the runaway prevention position information (see S113 in FIG. 3) is received (S401). The runaway prevention position information includes information indicating a position (that is, the runaway prevention position 60) where the vehicle 20B is to be arranged in order to cause the vehicle 20B to collide with the runaway vehicle 20A and forcibly stop the runaway vehicle 20A. For example, as shown in FIG. 7, the runaway prevention position 60 is located ahead in a traveling direction of the runaway vehicle 20A. The runaway prevention position 60 may be specified by the roadside device 10A during the processing in S113 in FIG. 3. For example, the roadside device 10A may analyze an image captured by the imaging unit 16, predict a traveling direction of the runaway vehicle 20A, and specify a position ahead in the traveling direction as the runaway prevention position 60.

When receiving the runaway prevention position information (S401: YES), the vehicle 20B determines whether the vehicle 20B can move to the runaway prevention position 60 indicated by the runaway prevention position information (S402). For example, when the vehicle 20B is an unmanned vehicle, or when the vehicle 20B is a vehicle (such as a large truck) that is sufficiently larger than the runaway vehicle 20A, it may be determined that the vehicle 20B can move to the runaway prevention position 60.

When the vehicle 20B can move to the runaway prevention position 60 indicated by the runaway prevention position information (S402: YES), the vehicle 20B moves to the runaway prevention position 60 and stops (S403), and returns the processing to S401. Accordingly, since the runaway vehicle 20A collides with the vehicle 20B and stops, damage to the surroundings can be minimized.

When the vehicle 20B cannot move to the runaway prevention position 60 indicated by the runaway prevention position information (S402: NO), the vehicle 20B determines whether runaway vehicle information is received from the roadside device 10A (S404).

When receiving no runaway vehicle information from the roadside device 10A (S404: NO), the vehicle 20B returns the processing to S401.

When receiving the runaway vehicle information from the roadside device 10A (S404: YES), the vehicle 20B notifies a driver that the runaway vehicle 20A enters the intersection (S405). For example, the vehicle 20B outputs audio indicating that the runaway vehicle 20A enters the intersection from the speaker 28, or displays an image indicating that the runaway vehicle 20A enters the intersection on the display unit 27. Accordingly, the driver of the vehicle 20B can notice the presence of the runaway vehicle 20A.

Then, the vehicle 20B automatically decelerates or stops (S406), and returns the processing to S401. Accordingly, the vehicle 20B can avoid contact with the runaway vehicle 20A.

### Summary of Present Disclosure

Contents of the present disclosure can be expressed as the following appendixes.

### <Appendix 1>

According to the present disclosure, there is provided a roadside device (10A) set to be installed at an intersection where a traffic light (5A) is installed, and the roadside device includes: an imaging unit (16) configured to image a vehicle (20A) that enters the intersection; an input unit (18) set to receive a state of the traffic light; and a wireless communication unit (14). When the traffic light for the vehicle is a red signal or is scheduled to switch to the red signal within a predetermined time, and a speed of the vehicle is equal to or greater than a predetermined threshold or the speed of the vehicle is increased, the wireless communication unit transmits information indicating that a runaway vehicle enters the intersection.

According to this configuration, the roadside device can detect the runaway vehicle with high accuracy, and when the runaway vehicle is detected, the roadside device can inform, for example, another vehicle (20B) or a mobile terminal (40) that the runaway vehicle enters the intersection by wireless transmission. Therefore, damage caused by the runaway vehicle can be reduced.

### <Appendix 2>

The roadside device (10A) according to Appendix 1 may further include: a control circuit (13). When the traffic light for the vehicle (20A) is the red signal or is scheduled to switch to the red signal within the predetermined time, and the speed of the vehicle is equal to or greater than the predetermined threshold or the speed of the vehicle is increased, the control circuit may cause the wireless communication unit to transmit the information indicating that the runaway vehicle enters the intersection.

According to this configuration, the control circuit (13) of the roadside device can detect the runaway vehicle with high accuracy, and when the runaway vehicle is detected, the control circuit (13) can inform, for example, the other vehicle (20B) or the mobile terminal (40) that the runaway vehicle enters the intersection by wireless transmission. Therefore, damage caused by the runaway vehicle can be reduced.

### <Appendix 3>

In the roadside device (10A) according to Appendix 1 or 2, when the traffic light for the vehicle is the red signal or is scheduled to switch to the red signal within the predetermined time, and the speed of the vehicle is equal to or greater than the predetermined threshold or the speed of the vehicle is increased, the wireless communication unit may transmit, by broadcasting, the information indicating that the runaway vehicle enters the intersection.

According to this configuration, the roadside device can inform, for example, the other vehicle (20B) or the mobile terminal (40) present near the intersection that the runaway vehicle enters the intersection by broadcast transmission. Therefore, damage caused by the runaway vehicle can be reduced.

### <Appendix 4>

In the roadside device (10A) according to any one of Appendixes 1 to 3, when the traffic light for the vehicle is the red signal or is scheduled to switch to the red signal within the predetermined time, and the speed of the vehicle is equal to or greater than the predetermined threshold or the speed of the vehicle is increased, the wireless communication unit may transmit, to a mobile terminal, the information indicating that the runaway vehicle enters the intersection.

According to this configuration, the roadside device can inform, for example, the mobile terminal (40) carried by a user present near the intersection that the runaway vehicle enters the intersection. Therefore, damage caused by the runaway vehicle can be reduced.

### <Appendix 5>

In the roadside device (10A) according to any one of Appendixes 1 to 4, when the traffic light for the vehicle is the red signal or is scheduled to switch to the red signal within the predetermined time, and the speed of the vehicle is equal to or greater than the predetermined threshold or the speed of the vehicle is increased, if it is determined that a guidance place is present, the wireless communication unit may transmit information indicating the guidance place to the vehicle.

According to this configuration, the roadside device can move the runaway vehicle to the guidance place. Therefore, damage caused by the runaway vehicle can be reduced.

### <Appendix 6>

In the roadside device (10A) according to Appendix 5, when the traffic light for the vehicle is the red signal or is scheduled to switch to the red signal within the predetermined time, and the speed of the vehicle is equal to or greater than the predetermined threshold or the speed of the vehicle is increased, if it is determined that no guidance place is present, the wireless communication unit may transmit information indicating a stop position to prevent the vehicle from running away to another vehicle different from the vehicle.

According to this configuration, the roadside device can prevent the runaway vehicle from running away by moving the other vehicle to the stop position where running away is prevented. Therefore, damage caused by the runaway vehicle can be reduced.

### <Appendix 7>

In the roadside device (10A) according to any one of Appendixes 1 to 6, when the traffic light for the vehicle is the red signal or is scheduled to switch to the red signal within the predetermined time, and the speed of the vehicle is equal to or greater than the predetermined threshold or the speed of the vehicle is increased, presence of the runaway vehicle may be notified through a predetermined speaker (17).

According to this configuration, the roadside device can inform, for example, another vehicle or a pedestrian present near the intersection of the presence of the runaway vehicle through the speaker. Therefore, damage caused by the runaway vehicle can be reduced.

### <Appendix 8>

In the roadside device (10A) according to any one of Appendixes 1 to 7, the wireless communication unit may receive a vehicle speed from the vehicle.

According to this configuration, the roadside device can specify the speed of the vehicle with high accuracy using the received vehicle speed, and thus can determine with high accuracy whether the vehicle is the runaway vehicle.

### <Appendix 9>

In the roadside device (10A) according to Appendix 8, the received vehicle speed may be the speed of the vehicle.

According to this configuration, the roadside device can specify the speed of the vehicle with high accuracy using the received vehicle speed, and thus can determine with high accuracy whether the vehicle is the runaway vehicle.

### <Appendix 10>

In the roadside device (10A) according to Appendix 8 or 9, the wireless communication unit may receive driver abnormality information transmitted from the vehicle when a state of a driver of the vehicle is abnormal.

According to this configuration, the roadside device can determine whether the state of the driver of the vehicle is abnormal based on the driver abnormality information transmitted from the vehicle (20A).

### <Appendix 11>

The roadside device according to Appendix 10 may determine that the vehicle (20A) runs away when receiving the driver abnormality information.

According to this configuration, the roadside device can determine that the vehicle (20A) is the runaway vehicle based on the driver abnormality information transmitted from the vehicle (20A). Therefore, the roadside device can determine with high accuracy whether the vehicle is the runaway vehicle.

### <Appendix 12>

A vehicle (20A) set to perform wireless communication with the roadside device according to any one of Appendixes 8 to 11, may include: a wireless communication unit (24) set to perform the wireless communication with the roadside device; and an alarm device (32), and execute audio emission control on the alarm device when receiving the information indicating that the runaway vehicle enters the intersection through the wireless communication unit.

According to this configuration, when the runaway vehicle enters the intersection, the vehicle can inform, for example, another vehicle or a pedestrian present near the intersection of presence of the runaway vehicle by sounding the alarm device. Therefore, damage caused by the runaway vehicle can be reduced.

### <Appendix 13>

The vehicle (20A) according to Appendix 12 may execute traveling deceleration control when receiving the information indicating that the runaway vehicle enters the intersection through the wireless communication unit. The deceleration control may include stop control.

According to this configuration, since the vehicle decelerates and/or stops when the runaway vehicle enters the intersection, the damage caused by the runaway vehicle can be reduced.

### <Appendix 14>

A vehicle (20A) for performing wireless communication with the roadside device according to any one of Appendixes 8 to 11, may include: a wireless communication unit configured to perform the wireless communication with the roadside device, and at least when a driver does not hold a steering wheel, the driver does not face forward, and a body temperature of the driver is equal to or lower than a predetermined threshold, transmit driver abnormality information through the wireless communication unit.

According to this configuration, the vehicle can more accurately determine whether a state of the driver is abnormal.

### <Appendix 15>

A control device (21) set to perform wireless communication with the roadside device according to any one of Appendixes 8 to 11 and configured to be mounted on the vehicle, may include: a wireless communication unit (24) set to perform the wireless communication with the roadside device, and execute audio emission control on an alarm device mounted on the vehicle when receiving the information indicating that the runaway vehicle enters the intersection through the wireless communication unit.

According to this configuration, when the runaway vehicle enters the intersection, the control device (21) can inform, for example, another vehicle or a pedestrian present near the intersection of presence of the runaway vehicle by sounding the alarm device. Therefore, damage caused by the runaway vehicle can be reduced.

### <Appendix 16>

The control device (21) according to Appendix 15 may execute traveling deceleration control on the vehicle when receiving the information indicating that the runaway vehicle enters the intersection through the wireless communication unit. The deceleration control may include stop control.

According to this configuration, since the control device (21) decelerates and/or stops the vehicle when the runaway vehicle enters the intersection, the damage caused by the runaway vehicle can be reduced.

### <Appendix 17>

A control device (21) set to perform wireless communication with the roadside device according to any one of Appendixes 8 to 11 and configured to be mounted on the vehicle, may include: a wireless communication unit configured to perform the wireless communication with the roadside device, and at least when a driver does not hold a steering wheel, the driver does not face forward, and a body temperature of the driver is equal to or lower than a predetermined threshold, transmit driver abnormality information through the wireless communication unit.

According to this configuration, the control device (21) can more accurately determine whether a state of the driver is abnormal.

Although the embodiment has been described above with reference to the accompanying drawings, the present disclosure is not limited to such an example. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

The technique of the present disclosure can be used for a roadside device, a vehicle and a terminal capable of wireless communication with the roadside device, and the like, and is useful for improving road traffic safety.

What is claimed is:

1. A roadside device set to be installed at an intersection where a traffic light is installed, the roadside device comprising:
an imaging unit configured to image a vehicle that enters the intersection;
an input unit set to receive a state of the traffic light; and
a wireless communication unit,
wherein, when the traffic light for the vehicle is a red signal or is scheduled to switch to the red signal within a predetermined time, and a speed of the vehicle is equal to or greater than a predetermined threshold or the speed of the vehicle is increased, the wireless communication unit transmits information indicating that a runaway vehicle enters the intersection.

2. The roadside device according to claim 1, further comprising:
a control circuit,
wherein, when the traffic light for the vehicle is the red signal or is scheduled to switch to the red signal within the predetermined time, and the speed of the vehicle is equal to or greater than the predetermined threshold or the speed of the vehicle is increased, the control circuit causes the wireless communication unit to transmit the information indicating that the runaway vehicle enters the intersection.

3. The roadside device according to claim 1,
wherein, when the traffic light for the vehicle is the red signal or is scheduled to switch to the red signal within the predetermined time, and the speed of the vehicle is equal to or greater than the predetermined threshold or the speed of the vehicle is increased, the wireless communication unit transmits, by broadcasting, the information indicating that the runaway vehicle enters the intersection.

4. The roadside device according to claim 1,
wherein, when the traffic light for the vehicle is the red signal or is scheduled to switch to the red signal within the predetermined time, and the speed of the vehicle is equal to or greater than the predetermined threshold or the speed of the vehicle is increased, the wireless communication unit transmits, to a mobile terminal, the information indicating that the runaway vehicle enters the intersection.

5. The roadside device according to claim 1,
wherein, when the traffic light for the vehicle is the red signal or is scheduled to switch to the red signal within the predetermined time, and the speed of the vehicle is equal to or greater than the predetermined threshold or the speed of the vehicle is increased, if it is determined that a guidance place is present, the wireless communication unit transmits information indicating the guidance place to the vehicle.

6. The roadside device according to claim 5,
wherein, when the traffic light for the vehicle is the red signal or is scheduled to switch to the red signal within the predetermined time, and the speed of the vehicle is equal to or greater than the predetermined threshold or the speed of the vehicle is increased, if it is determined that no guidance place is present, the wireless communication unit transmits information indicating a stop position to prevent the vehicle from running away to another vehicle different from the vehicle.

7. The roadside device according to claim 1,
wherein, when the traffic light for the vehicle is the red signal or is scheduled to switch to the red signal within the predetermined time, and the speed of the vehicle is equal to or greater than the predetermined threshold or the speed of the vehicle is increased, presence of the runaway vehicle is notified through a predetermined speaker.

8. The roadside device according to claim 1,
wherein the wireless communication unit receives a vehicle speed from the vehicle.

9. The roadside device according to claim 8,
wherein the received vehicle speed is the speed of the vehicle.

10. The roadside device according to claim 8,
wherein the wireless communication unit receives driver abnormality information transmitted from the vehicle when a state of a driver of the vehicle is abnormal.

11. The roadside device according to claim 10,
wherein the roadside device determines that the vehicle runs away when receiving the driver abnormality information.

12. A vehicle set to perform wireless communication with the roadside device according to claim 8, the vehicle comprising:
a wireless communication unit set to perform the wireless communication with the roadside device; and
an alarm device,
wherein the vehicle executes audio emission control on the alarm device when receiving the information indicating that the runaway vehicle enters the intersection through the wireless communication unit.

13. The vehicle according to claim 12,
wherein the vehicle executes traveling deceleration control when receiving the information indicating that the runaway vehicle enters the intersection through the wireless communication unit.

14. A vehicle for performing wireless communication with the roadside device according to claim 8, the vehicle comprising:
a wireless communication unit configured to perform the wireless communication with the roadside device,
wherein at least when a driver does not hold a steering wheel, the driver does not face forward, and a body temperature of the driver is equal to or lower than a predetermined threshold, the vehicle transmits driver abnormality information through the wireless communication unit.

15. A control device set to perform wireless communication with the roadside device according to claim 8 and configured to be mounted on the vehicle, the control device comprising:
a wireless communication unit set to perform the wireless communication with the roadside device,
wherein the control device executes audio emission control on an alarm device mounted on the vehicle when receiving the information indicating that the runaway vehicle enters the intersection through the wireless communication unit.

16. The control device according to claim 15,
wherein the control device executes traveling deceleration control on the vehicle when receiving the information indicating that the runaway vehicle enters the intersection through the wireless communication unit.

17. A control device set to perform wireless communication with the roadside device according to claim 8 and configured to be mounted on the vehicle, the control device comprising:
a wireless communication unit configured to perform the wireless communication with the roadside device,
wherein at least when a driver does not hold a steering wheel, the driver does not face forward, and a body temperature of the driver is equal to or lower than a predetermined threshold, the control device transmits driver abnormality information through the wireless communication unit.
